(19) United States
(12) Patent Application Publication
(10) Pub. No.: US 2017/0023074 A1
(43) Pub. Date: Jan. 26, 2017

(54) ONE-WAY CLUTCH

(71) Applicant: Caterpillar Inc., Peoria, IL (US)

(72) Inventor: Edward De Jesus Rivera, Peoria, IL (US)

(73) Assignee: Caterpillar Inc., Peoria, IL (US)

(21) Appl. No.: 15/289,818

(22) Filed: Oct. 10, 2016

(51) Int. Cl. F16D 41/12; F16H 41/24

(52) U.S. Cl. CPC F16D 41/12; F16H 41/24; F16H 2041/246

(57) ABSTRACT

A one-way clutch includes an outer cam having a plurality of pockets circumferentially space along an inner periphery. The one-way clutch also includes an inner race positioned coaxially within the outer cam. The one-way clutch further includes a clutch mechanism. The clutch mechanism includes a plurality of teeth provided in association with each of the plurality of pockets. Each of the plurality of teeth is adapted to selectively lock and unlock the outer cam and the inner race. The clutch mechanism also includes a plurality of biasing members disposed in each of the plurality of pockets. Each of the plurality of biasing members is adapted to keep the corresponding teeth in contact with the inner race.

### TECHNICAL FIELD

The present disclosure relates to a clutch, and more particularly to a one-way clutch for use with a stator in a torque converter.

### BACKGROUND

A transmission system associated with a machine, such as an off-highway vehicle, transmits power generated by a power source to a set of ground engaging members. The transmission system includes a torque converter having a stator and a one-way clutch positioned within the stator. The one-way clutch includes an outer cam and an inner race.

Traditional one-way clutches include rollers and springs to lock the outer cam and the inner race. Further, in an unlocked state of the one-way clutch, the outer cam or the inner race is free to spin at different speeds including opposite direction. The above mentioned designs of the one-way clutches tend to experience roller skewing and spring crushing. The skewing of the rollers occurs when an axis of the roller is not parallel to an axis of rotation. Such an event may cause inconsistent rotation of the outer cam and the inner race, which is undesirable.

U.S. Pat. No. 8,365,890 describes a one-way clutch. The one-way clutch includes an outer race. The outer race includes pockets having a cam surface. The outer race also includes projecting portions disposed inwardly in a radial direction. The one-way clutch also includes an inner race. The projecting portions of the outer race extend towards the inner race. The inner race is disposed away from the outer race in an inner diameter direction. The inner race is relatively disposed concentrically with the outer race. The inner race includes an outer peripheral surface. The one-way clutch further includes torque transmission numbers arranged in the pockets to transmit torque between the cam surface of the outer race and the outer peripheral surface of the inner race. The one-way clutch includes springs for urging the torque transmission members in such a direction that the torque transmission members mesh with the cam surface of the outer race. The one-way clutch also includes bearing members arranged between the outer race and the inner race. The bearing members are interposed between the projecting portions of the outer race and the outer peripheral surface of the inner race.

### SUMMARY OF THE DISCLOSURE

In one aspect of the present disclosure, a one-way clutch is provided. The one-way clutch includes an outer cam having a plurality of pockets circumferentially space along an inner periphery. The one-way clutch also includes an inner race positioned coaxially within the outer cam. The one-way clutch further includes a clutch mechanism. The clutch mechanism includes a plurality of teeth provided in association with each of the plurality of pockets. Each of the plurality of teeth is adapted to selectively lock the outer cam and the inner race in a first direction. Further, the each of the plurality of the teeth is also adapted to selectively unlock the outer cam and the inner race to allow at least one of the outer cam and the inner race, or both, to spin freely in a second direction. The second direction is opposite to the first direction. The clutch mechanism also includes a plurality of biasing members disposed in each of the plurality of pockets. Each of the plurality of biasing members is adapted to keep the corresponding teeth in contact with the inner race.

In another aspect of the present disclosure, a one-way clutch is provided. The one-way clutch includes an outer cam. The outer cam includes a plurality of pockets provided circumferentially spaced along an inner periphery of the outer cam. Each of the plurality of pockets includes a concave surface. Each of the plurality of pockets also includes a plurality of planar cam surfaces. Each of the planar cam surfaces are adjacent to one another. One of the plurality of planar cam surfaces is adjacent to the concave surface. The one-way clutch also includes an inner race provided coaxially with the outer cam. The one-way clutch further includes a clutch mechanism. The clutch mechanism includes a plurality of teeth provided in association with each of plurality of pockets between the outer cam and the inner race. The plurality of teeth includes a convex surface. The convex surface is adapted to engage with the concave surface of the outer cam. The plurality of teeth also includes a wedge surface. The wedge surface is adapted to engage the inner race. The plurality of teeth further includes a plurality of planar teeth surfaces. Each of the plurality of planar teeth surfaces are adjacent to one another. One of the plurality of planar teeth surfaces is adjacent to the convex surface. An another one of the planar teeth surface is adjacent to the wedge surface. The clutch mechanism also includes a plurality of biasing members. The biasing members are disposed in the plurality of the pockets between the outer cam and the plurality of the teeth. Each of the plurality of biasing members are secured to the corresponding planar cam surface. The biasing members are adapted to bias the plurality of teeth towards an outer periphery of the inner race.

Other features and aspects of this disclosure will be apparent from the following description and the accompanying drawings.

### BRIEF DESCRIPTION OF THE DRAWINGS

FIG. 1 is a cross-sectional view of an exemplary torque converter, according to the concepts of the present disclosure;

FIG. 2 is a front view of a one-way clutch and stator of the torque converter of FIG. 1, according to the concepts of the present disclosure;

FIG. 3 is a partial perspective view of a portion of the one-way clutch of FIG. 2, according to the concepts of the present disclosure;

FIG. 4 is a partial perspective view of a portion of an outer cam of the one-way clutch of FIG. 2, according to the concepts of the present disclosure; and

FIG. 5 is a perspective view of a tooth of the one-way clutch of FIG. 2, according to the concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

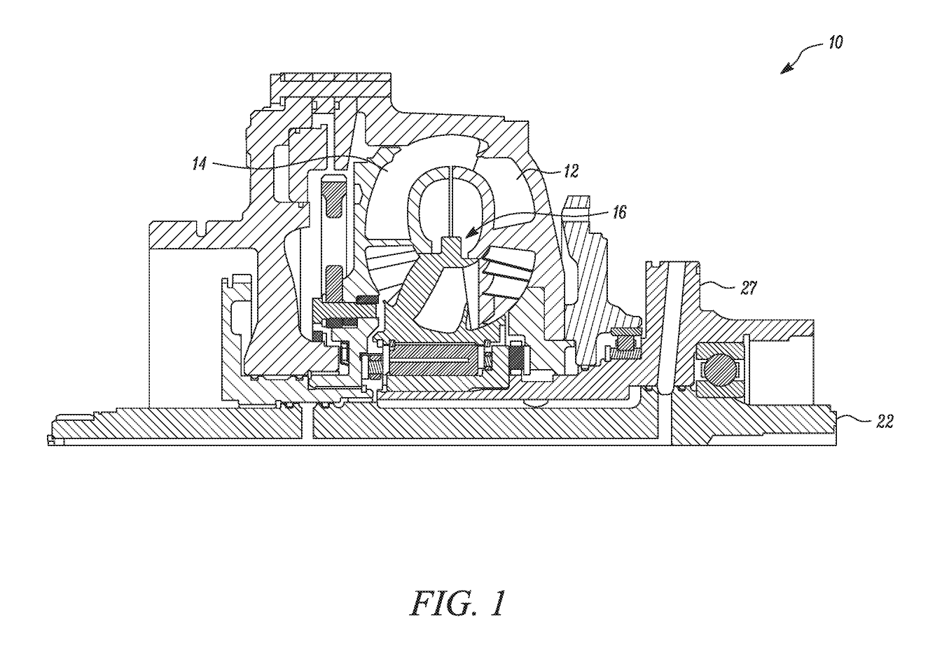

Referring to FIG. 1, an exemplary torque converter assembly 10 is depicted. The torque converter assembly 10 is used to transfer power between a power source (not shown) and a transmission system (not shown) of a machine (not shown). The machine may be a stationary machine or a mobile machine associated with an industry such as, mining, construction, farming, transportation, or any other industry known in the art. The machine may be an earth moving machine, such as a wheel loader, an off-highway truck, a motor grader, or any other suitable earth moving machine. The machine may also be an on-highway truck, a passenger vehicle, etc.

The power source produces a power output to provide motive force to the machine. The power source may embody an internal combustion engine, such as a diesel engine, a gasoline engine, a gaseous fuel-powered engine, or any other combustion engine. The power source may alternatively embody an electric motor coupled to a generator or some other source of electrical power. Further, the transmission system may include numerous components that assist in transmitting power from the power source to a set of ground engaging members (not shown) of the machine. In the illustrated example, the transmission system is embodied as an automatic transmission. Alternatively, the transmission system may include a manual transmission, without limiting the scope of the disclosure.

The torque converter assembly 10 includes an impeller 12 and a turbine 14. Further, a stator assembly 16 is positioned between the impeller 12 and the turbine 14. The impeller 12 rotates as a result of a rotational power input received from the power source. The rotation of the impeller 12 imparts a momentum to a fluid introduced in the impeller 12. The momentum of the fluid in turn causes a turbine shaft 22 of the turbine 14 to rotate, subsequently rotating the transmission system. In one example, the fluid is a hydraulic fluid.

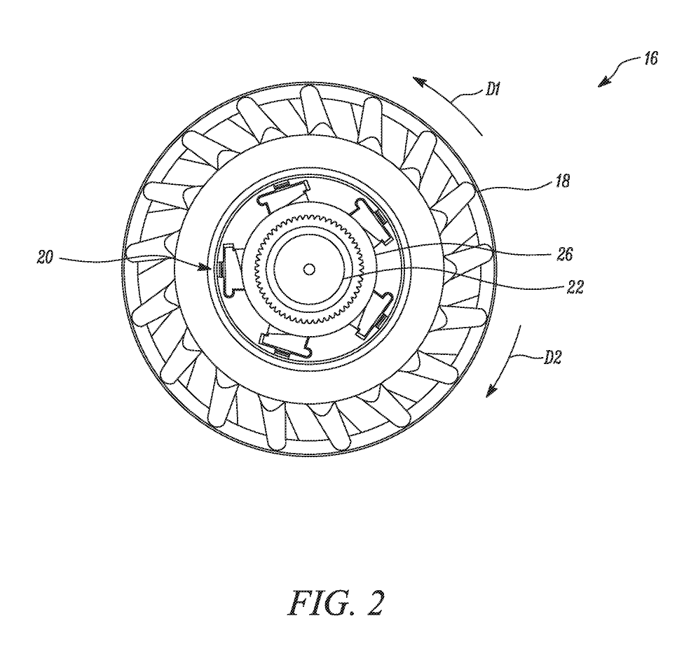

Referring to FIG. 2, the stator assembly 16 includes a stator 18 and a one-way clutch 20. The stator 18 is connected to an inner race 26 of the one-way clutch 20. In the illustrated example, the one-way clutch 20 allows locking of the stator 18 to prevent rotation of the stator 18 in a first direction “D1”. In this example, the first direction “D1” is embodied as a counter-clockwise direction. Further, the one-way clutch 20 allows the stator 18 to rotate or spin independent of the inner race 26 in a second direction “D2”. The second direction “D2” is opposite to the first direction “D1”. In this example, the second direction “D2” is embodied as a clockwise direction.

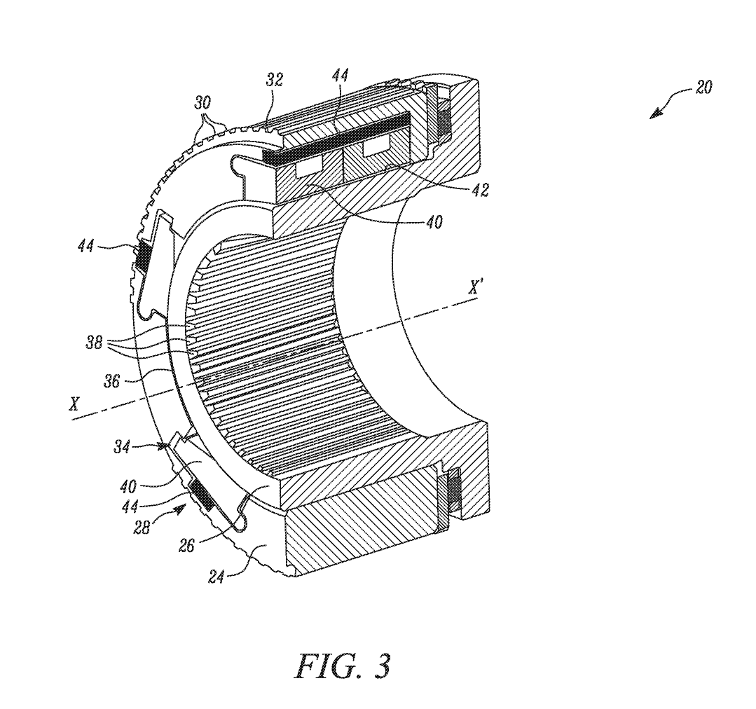

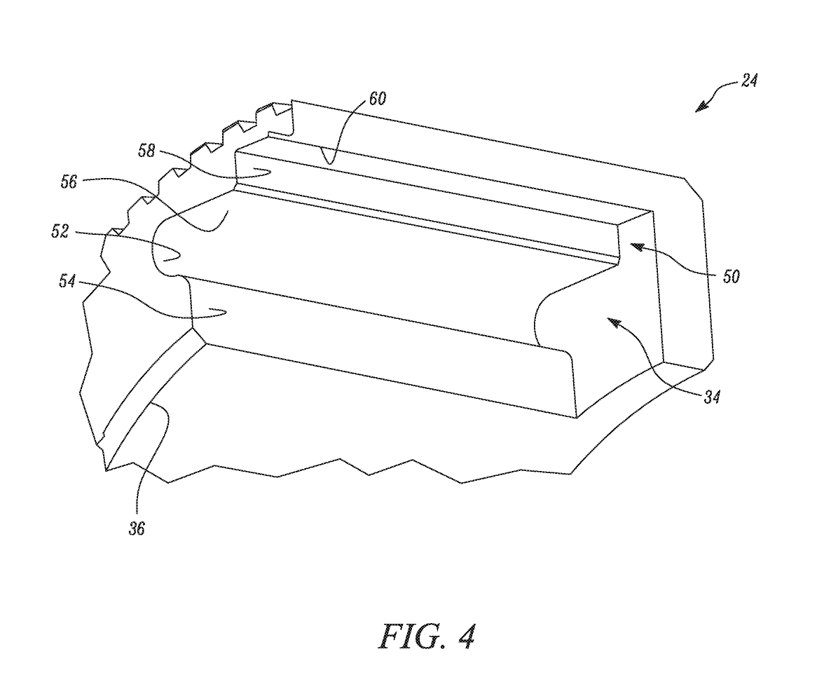

Referring to FIG. 3, the one-way clutch 20 includes an outer cam 24. In the illustrated example, the outer cam 24 is embodied as a spinning outer cam. The outer cam 24 includes a number of external splines 30. The external splines 30 are provided on an outer periphery 32 of the outer cam 24. The external splines 30 are received within internal splines (not shown) of the stator 18 to connect the outer cam 24 with the stator 18. Further, the outer cam 24 includes a number of pockets 34 which are circumferentially spaced along an inner periphery 36 of the outer cam 24. In the illustrated example, the outer cam 24 includes five pockets 34. Alternatively, the outer cam 24 may include more than five pockets 34, without limiting the scope of the disclosure. The number of pockets 34 may vary based on a size of the torque converter assembly 10. Each of the pockets 34 define a concave surface 52 (shown in FIG. 4), and a number of planar cam surfaces 54, 56, 58, 60 (shown in FIG. 4). The concave surface 52 is defined adjacent to the planar cam surfaces 54, 56. Further, each of the planar cam surfaces 58, 60 are defined adjacent to one another. Each of the pockets 34 include a slot 50 to receive a biasing member 44.

Further, the one-way clutch 20 includes the inner race 26. In the illustrated example, the inner race 26 is embodied as a stationary inner race. The inner race 26 is coaxially disposed within the outer cam 24. More particularly, the inner race 26 and the outer cam 24 are coaxially disposed on the turbine shaft 22 along an axis X-X′. The inner race 26 is coupled to a stator carrier 27 (shown in FIG. 1). A number of internal splines 38 of the inner race 26 are received within a number of external splines (not shown) on the stator carrier 27 in order to couple the inner race 26 with the stator carrier 27.

The one-way clutch 20 includes a clutch mechanism 28. The clutch mechanism 28 is provided between the outer cam 24 and the inner race 26. The clutch mechanism 28 engages the outer cam 24 with the inner race 26 to lock the outer cam 24 with the inner race 26. Further, the clutch mechanism 28 disengages the outer cam 24 and the inner race 26 to unlock the outer cam 24 and the inner race 26.

The clutch mechanism 28 includes a number of teeth 40 provided within the pockets 34. The teeth 40 selectively lock the outer cam 24 with the inner race 26 to prevent a rotation of the outer cam 24 in the first direction “D1”. Further, the teeth 40 selectively unlock the outer cam 24 and the inner race 26 to allow the outer cam 24 to spin freely in the second direction “D2”. The teeth 40 are provided within each of the pockets 34 defined between the outer cam 24 and the inner race 26.

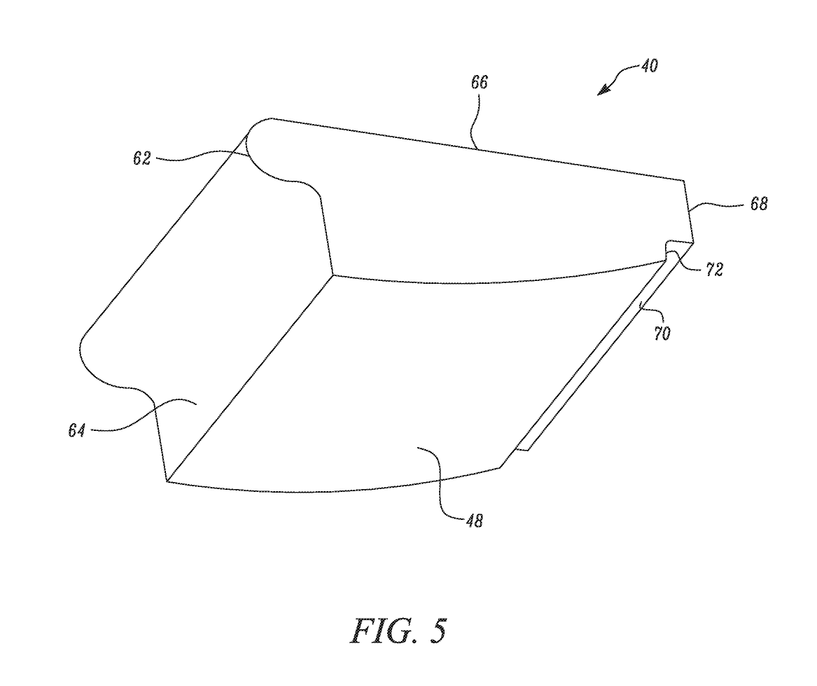

Referring to FIG. 5, each of the teeth 40 includes a convex surface 62. The convex surface 62 of each of the teeth 40 engages with the concave surface 52 of the respective pockets 34. The teeth 40 includes a wedge surface 48. The wedge surface 48 contacts the outer periphery 42 of the inner race 26. The teeth 40 includes a number of planar teeth surfaces 64, 66, 68, 70, 72. Further, the planar teeth surface 64 is defined between the wedge surface 48 and the convex surface 62. The planar teeth surface 72 is defined adjacent to the wedge surface 48. The planar teeth surfaces 66, 68, 70, 72 are defined adjacent to one another. Further, each of the planar teeth surfaces 64, 66, 68, 70, 72 engages with the respective planar cam surfaces 54, 56, 58, 60 and other planar cam surfaces not shown) of the pockets 34.

As shown in FIG. 2, each pocket 34 includes a pair of teeth 40. Thus, the clutch mechanism 28 includes ten teeth 40. In an alternate example, each pocket 34 may include a single tooth. In such an example, the clutch mechanism 28 includes five teeth 40 corresponding to the number of pockets 34. Further, a thickness of the single tooth defined along the axis X-X′ may correspond to a width of the pocket 34 that is defined along the axis X-X′.

Further, the clutch mechanism 28 includes the biasing members 44 provided in each of the slots 50 of the pockets 34. The biasing members 44 keep the corresponding teeth 40 in contact with the inner race 26. An upper portion of the biasing members 44 may abut to the planar cam surface 60 of the outer cam 24 and a lower portion of the biasing members 44 may abut to the planar teeth surface 66 of the teeth 40. In one example, the biasing members 44 are arranged in the slots 50 such that they urge the teeth 40 to contact the outer periphery 42 of the inner race 26. In one example, the biasing member 44 is an accordion spring. Alternatively, the biasing member 44 may be a coiled spring, or any other spring known in the art, without limiting the scope of the disclosure. Further, in some examples, the biasing members 44 may be disposed within an opening (not shown provided in the teeth 40, without any limitations.

Referring to FIGS. 2 and 3, the clutch mechanism 28 of the one-way clutch 20 prevents the rotation of the outer cam 24 in the first direction “D1”. Further, the clutch mechanism 28 allows spinning of the outer cam 24 in the second direction “D2”. In order to prevent the rotation of the outer cam 24 in the first direction “D1”, the clutch mechanism 28 locks the outer cam 24 with the inner race 26. Based on the flow of the fluid in the first direction “D1”, the outer cam 24 along with the teeth 40 locks with the inner race 26 to prevent the rotation of the outer cam 24 in the first direction “D1”. As the outer cam 24 rotates in the first direction “D1”, frictional forces between the wedge surface 48 and the outer periphery 42 of the inner race 26 cause the wedge surface 48 to grip the outer periphery 42 of the inner race 26. This gripping of the teeth 40 with the inner race 26 locks the outer cam 24 and the inner race 26 in the first direction “D1”.

Further, in order to allow the outer cam 24 to spin freely in the second direction “D2”, the clutch mechanism 28 unlocks the outer cam 24 and the inner race 26. More particularly, based on the flow of the fluid in the second direction “D2”, the outer cam 24 along with the teeth 40 rotate in the second direction “D2”. As the outer cam 24 rotates in the second direction “D2”, the frictional forces between the wedge surface 48 and the outer periphery 42 reduces, thereby causing the wedge surface 48 to slide over the outer periphery 42 of the inner race 26. The sliding of the wedge surface 48 over the outer periphery 42 unlocks the outer cam 24 and the inner race 26, thereby allowing the outer cam 24 to spin freely in the second direction “D2”.

### INDUSTRIAL APPLICABILITY

The present disclosure relates to the one-way clutch 20 that may be used in torque converter assemblies. Further, the one-way clutch 20 may be used in other applications that include one-way clutches, without limiting the scope of the present disclosure. Accordingly, the one-way clutch 20 may be utilized in a number of configurations, according to system requirements. The configurations may include any one of a spinning inner race with a stationary outer cam, a spinning outer cam with a stationary inner race, or the spinning inner race and the spinning outer cam, without any limitations. In various applications, the clutch mechanism 28 may lock the outer cam 24 and the inner race 26 to allow rotation of the outer cam 24 and the inner race in the first direction “D1”. Further, the clutch mechanism 28 may unlock the outer cam 24 and the inner race 26 to allow spinning of the outer cam 24, the inner race 26, or both, in the second direction “D2”.

In the illustrated example, the one-way clutch 20 locks the stator 18 in one direction, and allows spinning of the stator 18 in another direction. More particularly, the number of teeth 40 of the one-way clutch 20 selectively locks the outer cam 24 and the inner race 26 in the first direction “D1”. Further, the number of teeth 40 selectively unlocks the outer cam 24 and the inner race 26 to allow the outer cam 24, the inner race 26, or both, to spin freely at different speeds including opposite direction. The present disclosure provides a simple and ergonomic design of the one-way clutch 20. Further, as the one-way clutch 20 does not include rollers, problems associated with skewing of the rollers may be eliminated.

In operation, the outer cam 24 is allowed to spin freely in the second direction “D2”, whereas the outer cam 24 and the inner race 26 lock with one another in the first direction “D1” to prevent the rotation of the outer cam 24 in the first direction “D1”. This feature of the stator 18 provided by the one-way clutch 20 may increase efficiency gains and also increase an amount of power supplied to the transmission system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A one-way clutch comprising:
an outer cam having a plurality of pockets circumferentially spaced along an inner periphery thereof;
an inner race positioned coaxially within the outer cam; and
a clutch mechanism including:
a plurality of teeth provided in association with each of the plurality of pockets, wherein each of the plurality of teeth is adapted to:
selectively lock the outer cam and the inner race in a first direction; and
selectively unlock the outer cam and the inner race to allow at least one of the outer cam and the inner race, or both, to spin freely in a second direction, wherein the second direction is opposite to the first direction; and
a plurality of biasing members disposed in each of the plurality of pockets, wherein each of the plurality of biasing members is adapted to keep the corresponding teeth in contact with the inner race.

2. A one-way clutch comprising:
an outer cam comprising:
a plurality of pockets provided circumferentially spaced along an inner periphery of the outer cam, each of the plurality of pockets including:
a concave surface; and
a plurality of planar cam surfaces, wherein each of the planar cam surfaces are adjacent to one another, wherein one of the plurality of planar cam surfaces is adjacent to the concave surface;
an inner race provided coaxially with the outer cam;
a clutch mechanism including:
a plurality of teeth provided in association with each of the plurality of pockets between the outer cam and the inner race, wherein each of the plurality of teeth includes:
a convex surface adapted to engage with the concave surface of the outer cam;
a wedge surface adapted to engage with the inner race; and
a plurality of planar teeth surfaces, wherein each of the plurality of planar teeth surfaces are adjacent to one another, and wherein one of the plurality of planar teeth surfaces is adjacent to the convex surface, an another one of the planar teeth surface is adjacent to the wedge surface; and
a plurality of biasing members disposed in the plurality of pockets between the outer cam and the plurality of teeth, wherein each of the plurality of biasing members are secured to the corresponding planar cam surface, wherein the biasing members are adapted to bias the plurality of teeth towards an outer periphery of the inner race.
